(19) United States
(12) Patent Application Publication
(10) Pub. No.: US 2018/0330407 A1
(43) Pub. Date: Nov. 15, 2018

(54) System and Method for Transacting Trending Assets

(71) Applicant: Spotcrunch Pty Ltd, Carlingford (AU)

(72) Inventor: Ramesh NAGARAJAN, Carlingford (AU)

(73) Assignee: Spotcrunch Pty Ltd, Carlingford (AU)

(21) Appl. No.: 15/675,083

(22) Filed: Aug. 11, 2017

(30) Foreign Application Priority Data
May 15, 2017 (AU) 2017901800

(51) Int. Cl. G06Q 30/02; G06Q 50/00

(52) U.S. Cl. CPC G06Q 30/0277; G06Q 50/01; G06Q 30/0255; G06Q 30/0201; G06Q 30/0275; G06Q 30/0205

(57) ABSTRACT

The present disclosure is directed towards a system for transacting trending assets. The system comprising at least one metadata tag for sale, and wherein an entity makes a submission for the at least one metadata tag, via an application, accessible on an entity device. The submission for the at least one metadata tag being transmitted via the entity device to a server and wherein if the submission is confirmed by the system, the metadata tag is associated with the entity and wherein the metadata tag is viewable by a user via a user application on a user device.

Australian Provisional Application No. 2017901800, filed on May 15, 2017, is incorporated herein by reference in its entirety.

### TECHNICAL FIELD

The present invention relates to a system and method to provide product promotions based on a tending data set. More particularly, the system relates to a

[symbol]

### BACKGROUND

The Internet allows for publicization and promotion of individual tags, data sets, videos and images. Common tags or data sets used for promotion are known as “hashtags” which may be associated with an image, video, document or any other digital asset. The hashtag may be used to promote topic or product and will typically being with a hash symbol followed by a short message or word, commonly around 3 to 30 characters in length. With the proliferance of social media and online platforms, hashtags have become a marketing tool employed by many companies and organisations.

While hashtags are typically made by a single user and spread, these hashtags can increase in social value and therefore may also increase the desirability of a product or increase the value of a product or service. Some of the most commonly used hashtags may include: “Move”, “#instagood”, and “#photooftheday”. Hashtags may be used by a business to promote a product or service.

A hashtag management system permits a user to review a ranked or unranked list of hashtags that are correlated with an object of interest and to manipulate the list, such as by adding or deleting hashtags or by rearranging the ranking and to use the list for the purposes of contextual search and/or discovery. Based on the inputs of multiple users manipulating the hashtags, the system determines trends and/or preferences, search and/or discovery priorities and provides information about the trends and/or preferences to users who may use such information in order to select one or more of the hashtags for sharing across a social media platform and/or for the purposes of search and/or discovery. Additionally, the system facilitates the process by which the selected hashtags are shared across social media platforms in conjunction with the corresponding object and/or searching and/or discovering related objects.

Hashtags can be subjectively composed and may not always follow established and conventional grammar or spelling techniques. Due to its subjective origination, a particular hashtag may have more meaning to certain individuals or groups than another hashtag that strives to describe the same event, thing, or person; or convey the same meaning. In some cases, hashtags may be categorized around a singular event, thing, description, or person; however, in other cases hashtags may be a shorthand form of expressing emotion, for example, such as the hashtags (#TooMuchInformation, #Awesome).

Any discussion of the prior art throughout the specification should in no way be considered as an admission that such prior art is widely known or forms part of common general knowledge in the field.

### SUMMARY

### Problems to be Solved

The present disclosure may allow for an improved system for marketing.

The system of the present disclosure may provide for an improved digital asset transaction system.

It may be advantageous to allow for association of an entity with a digital asset and/or data set.

It may be advantageous to allow for association of an entity and a trending hashtag.

It may be advantageous to associate a product with a positive trending metadata tag.

It may be advantageous to provide improved customised search results based on customer preferences and/or likes.

It may be advantageous to restrict association of a trending hashtag with an entity.

It is an object of the present invention to overcome or ameliorate at least one of the disadvantages of the prior art, or to provide a useful alternative.

### Means for Solving the Problem

In a first aspect, the present disclosure is directed towards a system for transacting trending assets. The system comprising at least one metadata tag for sale and an entity being allowed to make a submission for the metadata tag. The application being accessible via an entity device. The submission for the metadata tag being transmitted via the entity device to a server and wherein if the submission is confirmed by the system, the metadata tag is associated with the entity and wherein the metadata tag is viewable by a user via a user application on a user device.

Preferably, the system collects data in relation to the entity geographical location. Preferably, the sale is an auction. Preferably, the sale is a fixed price. Preferably, a price for the sale is in relation to user feedback with respect to a number of shares of the metadata tag. Preferably, the metadata tag associated with the entity is assigned to at least one promotion. Preferably, the system issues a private key to the entity when the submission is confirmed by the system. Preferably, the user application displays a metadata tag feed on the user device. Preferably, the system displays an entity promotion with associated metadata tag in the user feed. Preferably, the metadata tag is assigned to a good for sale, in which the good for sale is displayable on a user feed. Preferably, the good for sale is a food item. Preferably, the system is adapted to capture at least one data set from a user at least when the user signs up for using the user application.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 illustrates a flowchart of an embodiment of a portion of the system of the present disclosure;

FIG. 2 illustrates a flowchart of an embodiment of a portion of the system of the present disclosure;

FIG. 3 illustrates a flowchart of an embodiment of a portion of the system of the present disclosure;

FIG. 4 illustrates a flowchart of an embodiment of a portion of the system of the present disclosure;

FIG. 5 illustrates a flowchart of an embodiment of a portion of the system of the present disclosure;

FIG. 6 illustrates a flowchart of an embodiment of a portion of the system of the present disclosure;

FIG. 7 illustrates a flowchart of an embodiment of a portion of the system of the present disclosure; and

FIG. 8 illustrates an embodiment of a “word cloud” (wordcloud) displaying examples metadata tags.

### DESCRIPTION OF THE INVENTION

Preferred embodiments of the invention will now be described with reference to the accompanying drawings and non-limiting examples.

A method and a system to provide product promotions based on real-time hashtag trends, that consumers can click to order, restaurants can bid to associate their product with a certain hashtag that is trending, applied through setting product classification and criteria by utilising consumer behaviour analytics and micro-targeting.

In one embodiment, the micro targeting logic preferably involves providing promotions to users who click on a specific hashtag, the restaurant's promotion results will be shown based on, and specific to user's location. Furthermore, the search results will be targeted towards users with specific cuisine preferences, dietary preferences, likes, whether they have bought the product before and whether it is from the same restaurant, number of reviews they provided for that “type” of menu or cuisine, whether they have commented on that product (by adding specific context related or particular sentiment related comments).

The platform uses PFM (position frequency matrix to determine where to show a specific restaurant or a specific promotion from a restaurant (which page, first page, second page so on) and how frequent the user can see the restaurants being listed (for e.g either during the duration of the promotion, or every day for one week, alternating day or max 3 continuous days). This determines that same restaurant will not be listed in the same position for more than a specific timeframe based on a rule. Clicking on the promotion results from a restaurant will take the user to the restaurant page where they can click to order the item.

An algorithm for use with an embodiment of the system of the present disclosure may be used to determine the content relevance promoted to the consumer, overall content relevance is a sum of specific promotion relevance is dependent on content viewed every day since the date that promotion is released by the service provider (restaurant).

The relevance score may be determined by targeting users with a high content relevant score, track the users timings (AT, AS), content relevance score=Position frequency score per campaign expressed in probability (%) rank.

This may be expressed as the following generalised equation:

$$\frac{\begin{matrix}Content Relevance to the promotion \times \\ Number of times content is viewed\end{matrix}}{\begin{matrix}User ’ s Total time spent in app \\ ( since specific promotion ) + Activity stream in app\end{matrix}}$$

Content relevance is calculated based at least one of the following group: history of the user, history of other users, affinity to that topic, user's cuisine and dietary preferences, current location Activity stream in app is calculated based on Number of likes, comments, flicks (shares), review sentiments all referencing a specific hashtag or restaurant. For example, the references may be “@restaurant” (wherein “restaurant” is the relevant entity) is or “#hashtag” (wherein “hashtag” is the relevant metadata tag).

The inputs from the users may include at least one of the following; dietary preferences, cuisines preferences, likes for a particular hashtag or family of hashtag (related by interests, diet, cuisine, location etc), number of times the hashtag is flicked, comments for a particular hashtag/product that reference that hashtag, number of times the hashtag is used, restaurants in users location promoting similar keywords to trending, hashtags, order last placed with the restaurants, last active within app, and metadata.

[Σⱼ₌₁^{m}Crj,Cvj/n(ATJ+ASJ)]/m

Crj=Content displayed for a specific promotion, measured by number of times the content is selected, Cvj=Content viewed for a specific promotion, measured by number of times the content is viewed by the user, “n”=number of days the content is active/published (default is 1), “m”=max number of promotions, “ATj”=total activity performed by the user since the promotion is active (measured in days), “ASj”=User's activity stream in days, “j”=number of promotions (default is 1).

Micro-targeting based on location may be achieved by the system. Showing restaurant promotions to users may be based on at least one of the following group; a user's location, match the cuisine based on user preferences then filter on dietary preferences, rank according to promotion due date, apply filters based on whether the user has bought that menu item previously from that restaurant or from some other restaurant, determine position and frequency of the promotion by randomizing the rank of the search list based on: number of likes for that type of product, positive sentiments in comments or reviews for that type of product or restaurant and whether restaurant has paid for the sponsored hashtag listing.

A user can be targeted based on their relative location, however other parameters may further be used to target a user. Restaurant options are promoted to users based on at least one of a user's location, a preference of the user, at least one filter, at least one filter applied by a user, dietary preferences, dietary requirements, a restaurant ranking, a date, a weekday, a weekend, a whether a user has previously purchased a menu item from the restaurant, a whether a user has previously purchased a menu item from a similar restaurant and the ranking of a restaurant.

The position of a restaurant may be dependent on the number of likes over a period of time. The period of time may be any time period, such as; at least one minute, at least one hour, at least one day, at least one week, at least one month, or a combination of any of the aforementioned.

Restaurants can get real-time #hashtags through word-cloud or a list of hashtags that tells them what is trending in their restaurant and all near-by restaurants in their area or near-by restaurants in their location serving same item, resulting in them using the same or similar keywords in their product to attract users.

Restaurants can view and update the suggested hashtags that are trending under the relevant product name in the product listing (menu listing) page —Restaurants can associate any number of hashtags to a product item, sometimes involving both english and other language conventions that represent the product in their local country or in other words, the hashtags that restaurants associate with their product will be location based and only visible for people in certain locations. Where hashtags are being shared with people across different countries with different language constraints, the hashtags will be converted to their user's chosen language.—for example (for product Pizza, a hashtag #pizza #special-deal could be associated as well as pizza in chinese [symbol] ). —the chinese [symbol] will be visible for people who are associating pizza for example, in their specific location in china, with chosen language of mandarin

Restaurants can bid on a specific #hashtag (by paying a fee) that either promote their restaurant or a specific menu item from the restaurant that match the hashtag that is trending—Restaurants paying a fee associating a given hashtag with their product, those that pay a fee will be ranked higher than those restaurants which have not paid a fee

User's view: —Users can view Trending hashtags by clicking on Trending tab (refer to pic) —The trending tab will list hashtags relevant to user's location as well as global hashtags —Trending hashtags will have the name of the hashtag (e.g., #pizza) and the number of times that hashtag has been flicked (or shared) —Trending page will list the top trending hashtags in the given user's location —Clicking on that hashtag (#pizza or #Buy1Get1) will show all the posts relevant to that #hashtag ie., #pizza, #buy1get1 (again either locally or globally, based on user's choosing). —the hashtag (e.g., #pizza) search result page will include the restaurants in the area serving #pizza. The logic is dependent on user's location, cuisine preferences, likes, comments etc (as described in restaurant's view, see “Method”). The restaurants shown in the #hashtag page is intended to be unique to an individual.

Deals —Users can follow hashtags (as shown in pic), based on cuisine preference and location. —an example, you are interested in #lastminutedeals lets say and lets say all the restaurants subscribe to that hashtag because they always throw away food at the end of the day, but before they do that they list all their products under #lastminutedeals —and for people who follow #lastminutedeals, they can see what restaurants are putting things on last minute.

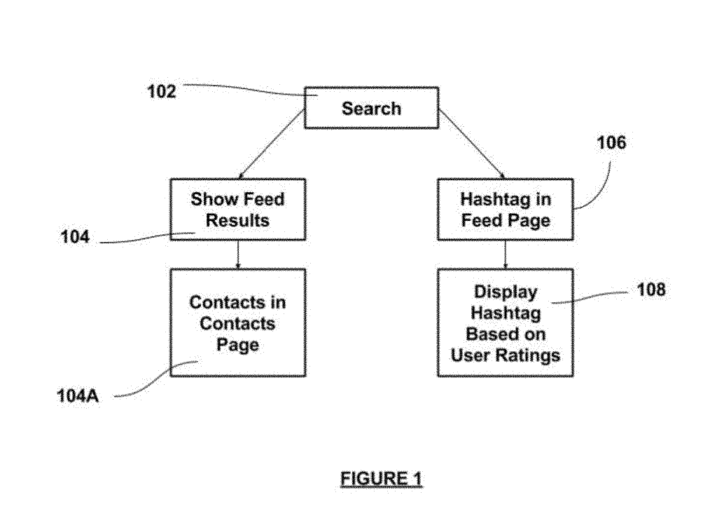

Referring to FIG. 1 there is illustrated an embodiment of a user enrolment process. The process further includes options for a user to use within the application. In addition, FIG. 1 also illustrates an embodiment of a search display 102 which may act as a home page for a user. The homepage may allow a user 10 to view at least one of; restaurants in the feed, contacts in contact page, trending hashtags, upcoming hashtag, new hashtags and popular hashtags, and hashtags based on previously used user hashtags.

The enrolment process may request details related to a user and/or the device and/or peripherals of the device. The enrolment process may request for access to at least one application of the device, or peripheral component of the device, such as a camera or stored files.

A search 102 may be carried out in which feed results can be displayed 104 and optionally contacts associated with the user profile 104A. At least one hashtag may be displayed in the feed 106 and the hashtag(s) displayed may be based on user postings 108. The search 102 may be automatically performed when a user opens or accesses the application or may be manually input.

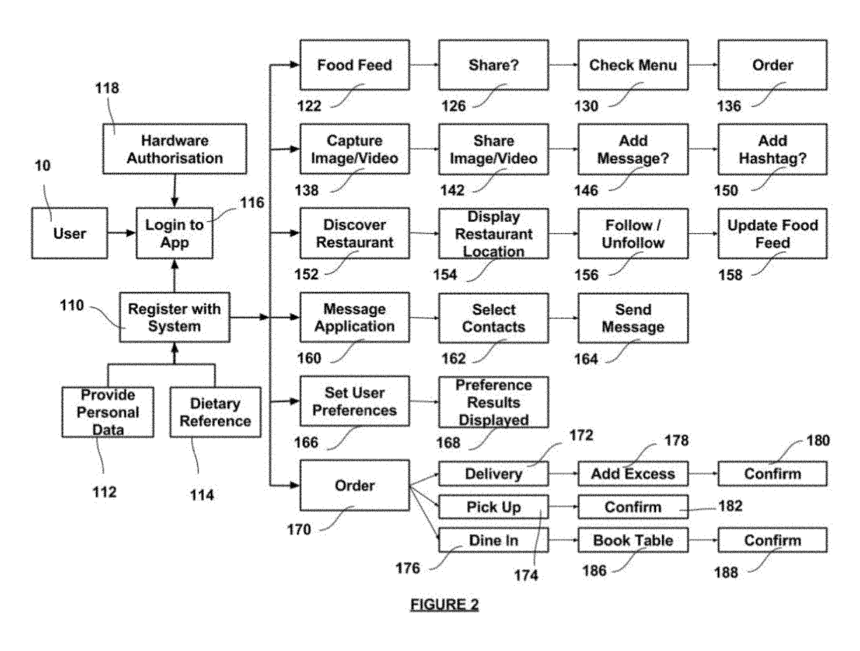

Referring to FIG. 2, there is illustrated a flowchart 100 in which a user 10 may register a user profile with the system 110. The user profile preferably comprises personal data of the user 112 such as at least one of; a name, email address, a username, payment details, delivery address, birth date or any other predetermined data set. It will be appreciated that any data fields may be requested from the user, although these may be optional for the user to complete if desired by the system. Optionally, the user may provide preferences in relation to desired products 114. For example, in the case of food products the user may provide dietary preferences such as “vegetarian” options, “vegan” options, and “dairy free” options or any other desired preferences or dietary requirements.

After generating an account the user may login 116. The user profile may optionally be associated with a mobile number, cellular number, sim card or any predetermined hardware of the device being used. While FIG. 2 illustrates a search 120 option only after logging in to the application, the application may allow for searching 120 without generation of a user account. However, the user may be prompted to make an account before purchases or actions are made on the system. Searching 120 be optional and a user may login to the system or application without searching before being provided with options to view a feed 122, capture a video/image 138, discover restaurant 152, message 160, user preferences 166 and/or ordering 170.

Searching 120 may provide search results in relation to a food feed 122. The location details of the user may be used to filter results shown. Further, if any dietary preferences are associated with the user profile these may also influence the results shown to the user. The user may also follow or unfollow hashtags. From the results in the food feed, the user may elect to share 126 via a share function 128 at least one item from the food feed 122. The user may also elect to order from the food feed 130. The user may select the restaurant page 132 from the food feed and elect items from the menu 134 and then place an order 136.

Media, such as images, gifs, and videos may be shared 138 via the system with the use of a share function. A hashtag may also be provided such that at least one of; a restaurant, a product name, a feeling, or any other hashtag or metadata tag may be associated with an image or video. The image or video may be shared with friends 142 or on a public forum for example. If the media is being shared with friends, each desired contact may be selected or undesired contacts may be unselected if all contacts are selected by default 144. A message may be associated with an image or video 146 and preferably a hashtag. After electing whether to attach a message to the image or video, the image or video can be sent 148. If a hashtag is associated with the image or video the image may be searched for via the hashtag 150.

The user may also search for a restaurant 152 by proximity or location 154. Optionally the user may input a postcode, GPS data or a desired town or city. The distance of the search may be based on the number of results or a distance length from the desired location. A number of results may be shown to the user regardless of distance from the user if there is a minimum result display assigned. For example, the minimum result display may be 20 restaurants, which may be at any distance, provided that the closest 20 restaurants are displayed to the user. The user may also elect to ‘follow’ a restaurant 156 such that promotions and/or updates by the restaurant may be sent to the user or be notifications to the user. The user may also elect to unfollow a restaurant. An updated food feed 158 may then be displayed to a user if a user elects to follow or unfollow a restaurant.

At a later time, the user may set preferences or dietary requirements 166, and hashtags or metadata tags related to these dietary requirements may be promoted to a user 168. The user may have an order option 170 in which the user may order food for delivery 172, pick-up 174 or dine in 176. If the delivery option 172 is selected, the user may be required to pay a delivery fee 178 and then confirm payment once the menu items are selected 180. If pick up 174 is selected the menu items are selected 182 and then the user may be allowed to order the menu items selected after payment of relevant fees for the menu items. A dine in reservation 176, or sit in reservation, may be booked via the application. The user may be allowed to select or request a specific table or dining location within the venue. The user may then book the table and/or menu times selected to reduce waiting time. In this way, a user may be able to enjoy a meal which requires a significant time to prepare without waiting for the preparation time. If menu items are selected the user may also be required to pay upfront for the menu items to ensure that the venue does not prepare a meal which is not going to be paid for.

A home page and/or a user interface may be provided by the application for locating restaurants with respect to trending hashtags and/or hashtags previously used by the user profile 10 or contacts associated with the user profile 10.

It will be appreciated that at least algorithm is used to generate the displayed restaurants to the user. In one embodiment, the algorithm may employ a position frequency matrix (PFM) and/or a position weight matrix (PWM). It will be appreciated that the algorithms may be dynamic such that the featured hashtags and/or restaurants can be updated in real time or with a desired lag time. The system may employ a learning function such that the

[symbol]

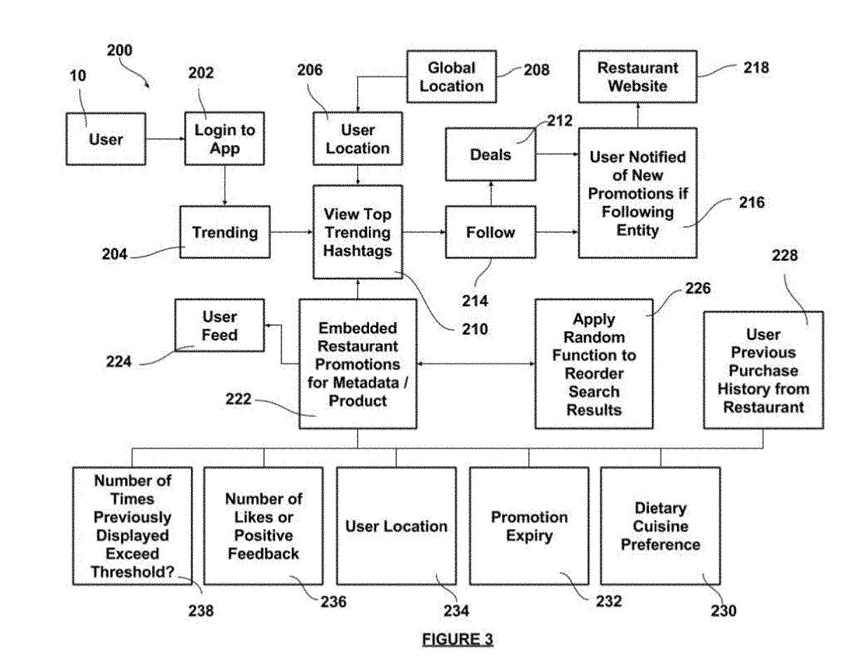

FIG. 3 illustrates an embodiment of the restaurant authorised user log in process 200 and options which may be available to a restaurant authorised user 10. The restaurant authorised user may be any person who may be allowed to act on behalf of a restaurant and/or provider of a service. The user 10 may log into the application 202 and view the presently trending metadata tags, or upcoming trending metadata tags 204. The top tending metadata tags may be viewed 210 in which the user may elect to follow at least one metadata tag 214 for data analytics. The top trending metadata tags may be in relation to a global location of the venue 208 and/or a location of the user 206. The location of the user may be manually input by the user or may be based on a GPS location if desired. Embedded restaurant promotions 222 may also be shown when viewing the top trending metadata tags. The embedded restaurant promotions may be in relation to a specific product or metadata tag and may also be viewable on a user feed 224. A function, such as a randomiser function, may also be applied to the embedded restaurant promotions associated with at least one metadata tag such that the results will vary when viewed on a user feed 224. The embedded restaurant promotions may also include data in relation to the number of times the promotions have been displayed 238. The number of times in which a promotion has been displayed may be capped or restricted to a threshold before becoming less visible, or may be less visible unless an owner of the promotion elects to provide more funds to increase the threshold. The data for the embedded threshold may also include data in relation to positive feedback of users 236 or the number of likes or other positive datasets. In this way the promotion may be more visible for longer if users are positively receptive to the promotion, which can improve the relationship between the business (e.g. restaurant) and the consumer. The shown embedded promotions may also be in relation to a user location 234, a promotion expiry date 232, or a dietary or cuisine preference. Further, shown embedded promotions may also be in relation to previous purchases from the user 228, or friends of the user. Access to previous restaurants by geotagging may also be used by the system to predict potential restaurants the user may wish to dine at or purchase goods from.

In the user elects to follow 214 at least one metadata tag, the user may receive deals or promotions in relation to that metadata tag 121. The user may be notified of new promotions if the user is following an entity or business 216 also. The promotion and/or deal may also provide a link to visit a an Internet page, such as a webpage.

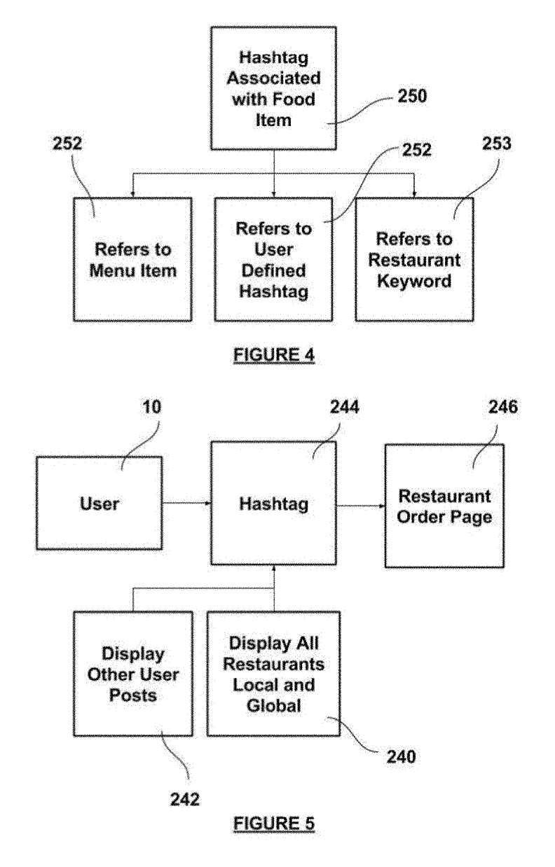

FIG. 4 illustrates a further embodiment of a restaurant login and options which may be displayed in relation to a restaurant profile. The restaurant profile may have access to a hashtag bidding option in which a hashtag may be bought for use on the application and/or the data associated with the hashtag may be purchased or bid on. Hashtag bidding may be within a relatively small time frame as hashtags or trending data sets may only be trending for a matter of hours or days. The hashtag may also be bid on and used for a predetermined time period, such as a period of 24 hours before the hashtag is again listed for bidding. Restaurant profile users will then consider the value of the hashtag and be able to tailor promotions and/or products to a desired demographic more easily.

FIG. 4 illustrates a flow chart of potential metadata tags 250 and to elements that they may be associated with. The metadata tag may be associated with a menu item 251, or a user may define a metadata tag and associate the tag with a restaurant and/or item on the menu 252, or a metadata tag may be associated with a restaurant keyword 253. It will be appreciated that any combination of the aforementioned may also be achieved in at least one embodiment of the system. The system may further allow for any metadata tag to be assigned by a user; however a separate feed weighting may optionally be applied to the user metadata tag such that a restaurant metadata tag may elevate the restaurant ratings relatively more compared to the user metadata tags. In this way entities cannot game the system or artificially elevate their feed ratings. Optionally, the system may allow for the same weighting of the user metadata tags and the restaurant tags when the user account or user profile has been verified.

Turning to FIG. 5, there is shown a schematic in which a user can view a hashtag 244 in a feed. The hashtag 244 can be any desired metadata adapted to be viewable by a user 10 of the system. The hashtag may be associated with at least one user post and/or restaurant. At least one user post associated with the feed hashtag (or selected feed hashtag), if available, can be displayed to a user 10. Further, at least one restaurant is using the hashtag, an image and/or promotion associated with the hashtag may also be displayed to a user 10. The feed may randomly sort or display the images or posts associated with a hashtag to a user when viewing the feed. Selecting the hashtag may also allow for access to an online store or webpage of the entity 246, such as a restaurant order page. While a restaurant entity is referred to within this specification, the entity may be any vendor or other business (private or public).

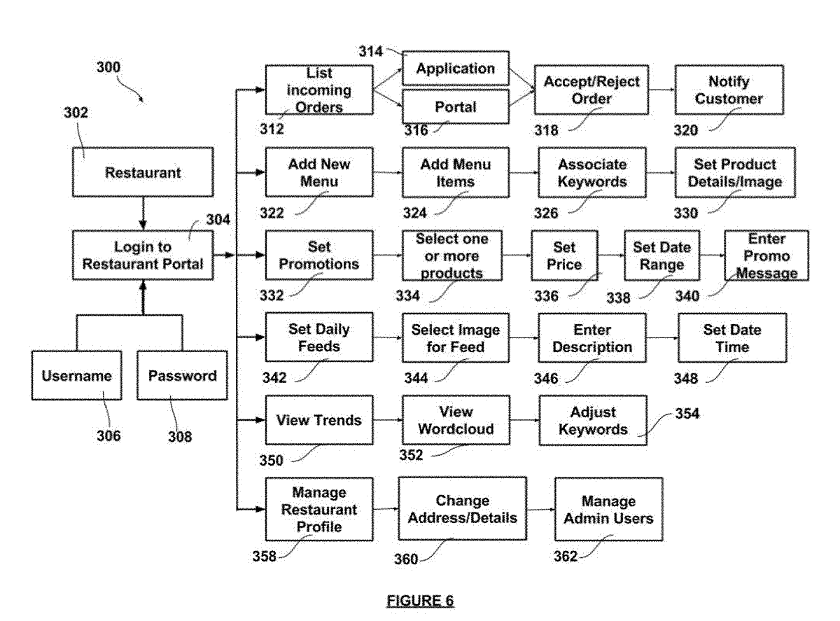

FIG. 6 illustrates a flowchart of an embodiment of a process for a restaurant user to log into the system and manage a restaurant profile 300 and associate metadata with at least one promotion, deal, discount, or advertisement. The restaurant 302, or restaurant profile user 302, can log into the system if an account has been generated. A username 306 and password 308 can be input into the login portal 304 to allow access to the system 300. After logging into the system or signing into the system 300, the user of the restaurant profile 10A may have access to a number of options. Options may comprise viewing a list of upcoming orders 312, adding a new menu item 322, setting at least one promotion, discount, deal or advertisement 332, setting daily feeds 350, viewing trends 350, viewing data, or managing the restaurant profile 358.

Viewing a list of incoming orders 312 may allow a restaurant to filter incoming orders such that at least one order may optionally be prioritised or cancelled. Cancelling an order may be desirable if a payment has been rejected or the order is from a potentially undesirable customer. If an order is accepted or rejected 318, for any desired reason, the customer can be notified of the acceptance or rejection 320. Notification may be via any conventional means, such as a text message, a phone call an email or any other desired means of correspondence. The order may then be made and delivered to, or picked-up by, the client if the order is accepted.

The restaurant profile may have the option to add a new menu 322 by importing a menu from a website, manually input, or imported from another data source, to be accessible by the system, or be viewable by a user of the system. Once a menu has been uploaded, at least one menu item may be assigned or removed from the menu. Keywords may be associated with at least one menu item, in which a keyword may be a hashtag or other metadata tag. This keyword is preferably a paid for hashtag or other purchased metadata tag, or may be assigned a food preference tag, such as ‘vegetarian’ and/or ‘vegan’, for example. Menu items may optionally have a product description and/or image added such that additional details can be displayed to a user or customer.

At least one promotion, deal, discount or advertisement may be set or uploaded 332. At least one product may optionally be associated with the promotion, or the promotion may be a discount on a food package or discount on an overall order. If the discount is associated with a menu item, a specific price or specific discount percentage may be set to the said menu item or menu item range. A predetermined promotion period, or predetermined time period, may be associated with the menu item or menu item range. A promotion message may further be issued to at least one user, or be adapted to pop-up, or be present when accessing a trending metadata tag, or present in a user feed. The promotion message may include text, video, gif, images, audio or any combination thereof.

Daily feeds, daily promotions or daily deals may be set 342 for a restaurant via the restaurant profile. While the term “daily” may be a single period of time being 24 hours, optionally a “daily feed” may be of any predetermined period of time, such that the feed may last multiple days, hours, minutes, weeks, months, years, or any other predetermined time period. The daily feed image may be selected 344. The image for the feed may be a gif, a static image, a video or any other media or multimedia message. A description may be associated with the daily feed 346 and a time and/or date may further be associated with the feed such that the feed it only active or viewable when desired.

The user of the restaurant profile may further view trending metadata tags 350 such that a dynamic marketing strategy may be employed by the restaurant. A dynamic marketing strategy may improve sales of a business and be related to a temporarily popular metadata tag. Assigning a promotion to a metadata tag may improve sales and more efficiently promote an entity, such as a restaurant. Further, associating a metadata tag with at least one feed may improve the visibility of the entity to which the feed is associated with. A word cloud (also referred to herein as “wordcloud”) may be viewed 352 which comprises multiple words which may be associated with portions of metadata tags. For example, the metadata tag “#ILoveTheMovies” will have the portions “I”, “Love”, “The” and “Movies”, in which the most common portions of the metadata tag can be added to the pool of the wordcloud. It will be appreciated that some words may be excluded from the pool, such as “I” and “The” such that common words without potential significant meaning may not be ranked as trending terms in the pool. Filtering the metadata components may provide for a pool of the most popular words which excludes a portion of the most common words, for example the ‘Oxford English Dictionary’ top one hundred most common words may be excluded.

Optionally, a metadata tag may be used as a promotion code, such that if a user uploads a hashtag or other metadata tag when purchasing an order of food, a discount may be applied. For example, an image of a user's order may be a pasta salad, however to receive a promotion the hashtag may be “#PepperoniPizza” which may be a separate item on the menu or an unrelated term. In this way the hashtag or metadata tag can be promoted even further and increase the value and/or marketing potential of the metadata tag. Promotion of the metadata tag and/or further use of the metadata tag may further be used to elevate an entity's rating in a feed of the system. Optionally, the system may restrict the number of entities using a hashtag or metadata tag, at least on the system. Allowing for a monopoly or a limited number of users on the system to exploit a metadata tag may provide additional incentive for entities to generate new metadata tags.

In yet another embodiment, a metadata tag may increase in price to use for a predetermined time period. In this way metadata tags can be cycled as eventually the most popular metadata tags will be abandoned after a period of time due to expense. Therefore, newer metadata tags can become the most popular tags when the most expensive tags are abandoned. There may be a predetermined price and/or last for a predetermined time period. If there is a predetermined time period, at the expiry or near to the expiry of the time period the current entity holding the metadata tag may be prompted to renew the use of the metadata tag if desired.

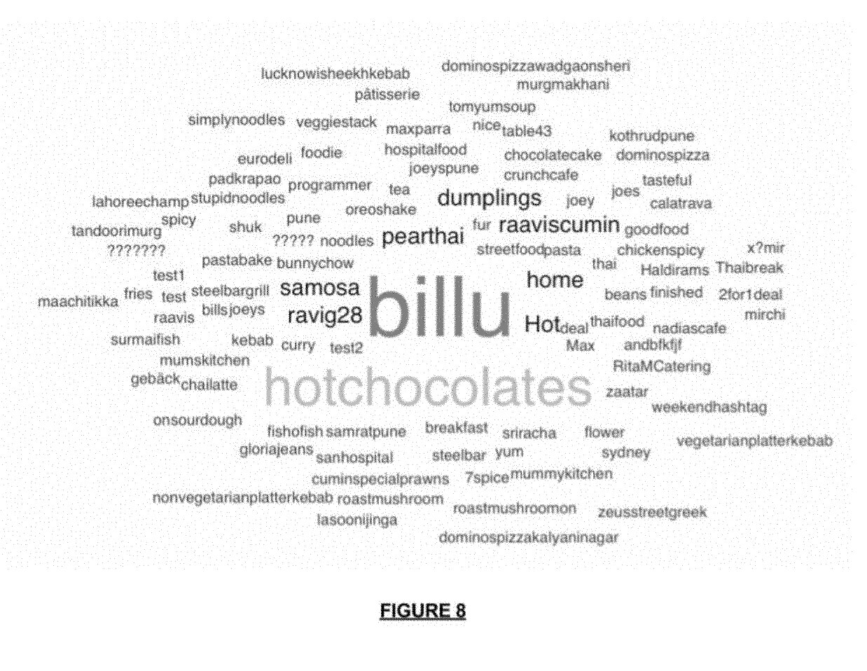

Referring to FIG. 8, there is illustrated an example of a wordcloud which may highlight popular metadata tags, or portions thereof. Wherein the larger the word (or term) and/or the more centralised the word or term relative to the surrounding words, the more likely the word is to be of significance at that point in time. For example, as illustrated, the most prominent word is “billu” and is larger than other text and centralised relative to the surrounding text. Any words which are prominently displayed may be more expensive to purchase, rent or use.

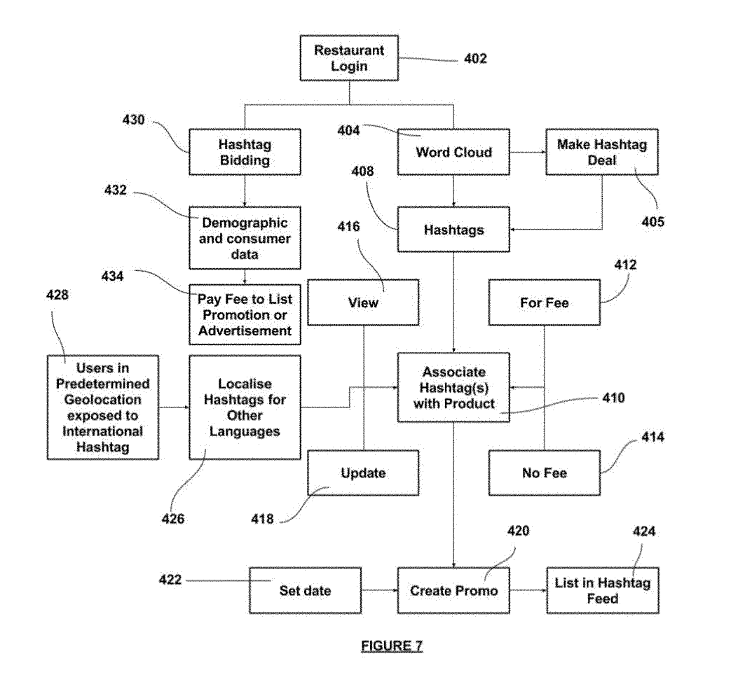

FIG. 7 illustrates a flowchart of an embodiment of a process for an entity to associate a metadata tag with a product. After an entity, such as a restaurant, logs in via a respective entity profile, metadata tags can be bid on or purchased 430 via the entity profile. Optionally, demographic and consumer data may be available to view in relation to a selected metadata set 432. For example, a metadata set for a hashtag may be viewed by the restaurant profile to target specific demographics or consumer bases. The restaurant profile user may elect to purchase or bid on a desired hashtag, and if the purchase is confirmed, either a fixed price purchase or a bid, the restaurant profile must pay a fee before being able to use an associated metadata tag and/or download demographics and/or consumer data. After payment the restaurant profile may be allowed to associate the purchased metadata tag with at least one promotion and/or product.

Alternatively, the restaurant profile may access a word cloud 404 with potential metadata tags or words which can be used to generate a new metadata tag. If a new hashtag is made, the restaurant profile may optionally associate a deal or promotion with the metadata tag 405. The word cloud may also offer suggestions with regards to upcoming or new metadata tags and may offer suggestions based on a locality of a restaurant. For example, a trending or upcoming trending metadata tag may be “#OlymipicGold” and may be desirable in a country where the Olympic Games are to be held or are being held. Once a hashtag has been generated or selected, the hashtags may be associated with at least one product of the restaurant or a promotion. A fee 412 may be paid to prioritise search results within the system. If no fee is paid 414, the default restaurant search results may be displayed to a user. In this way, an entity, such as a restaurant, which has paid a fee may have their promotion or hashtag shown in the top results, this is to say the priorities results. A view option 416 may also be provided to allow for an entity to view trending metadata tags, such as hashtags, and optionally the entity may be permitted to update 418 the latest product specific hashtag which is trending. It will be appreciated that the update may occur in real time such that an entity can react to trending metadata or shift a promotion or advertising stance to best suit their requirements. A promotion, deal and/or coupon may be generated with respect to the metadata tag 420. A set date may be associated with the promotion, deal and/or coupon such that there is a starting date and preferably an expiry date of the promotion, deal and/or coupon. After all desired parameters of the metadata tag have been generated and/or assigned; the metadata tag can be uploaded to the system for display in a user feed 424.

Optionally, users in a predetermined geographical location may be exposed to international metadata tags 428, and said international metadata tags may be related to hashtags which are trending in more than one jurisdiction or international location. The metadata tags may also be converted from a foreign language 426 to a local language or a preferred language of the user. Data from 426 and/or 428 may be used to associate a metadata tag (such as a hashtag) with a product 410.

Entities, such as a restaurant, can view and update suggested hashtags that are trending under product names in a product listing (menu listing) page. Entities may associate any number of hashtags to a product item in which any hashtag or metadata tag symbol or desired language can be used for the metadata tag assigned to at least one product and/or menu item. This may then allow for promotion in any desired jurisdiction, for example, if the restaurant is in an international terminal or location having multilingual metadata tags may allow for targeting a maximum number of users using the app.

English and other language conventions which may represent the product in their local country or in other words, the hashtags that restaurants associate with their product(s) will be location based and only visible for some users in predetermined locations. Optionally, the predetermined location may instead be a random location. Where hashtags are being shared with people across different countries with different language constraints, the hashtags will be converted to their chosen user language. For example (for product Pizza, a hashtag #pizza #special-deal could be associated as well as pizza in Chinese [symbol] ). The Chinese [symbol] will be visible for people who are associating pizza for example, in their specific location in China, with chosen language of mandarin.

An entity, such as a restaurant may wish to promote their business in combination with a trending hashtag or other trending data set. An entity may be required to pay a higher fee dependent on the hashtag and/or how likely the hashtag is to trend and/or remain trending. This is to say that new or upcoming hashtags may be discounted or be of a lesser fee to purchase until at least one threshold is reached, wherein the at least one threshold may be indicative or historically likely to represent a hashtag which will or is probabilistically likely to trend. In this way the price is matched or associated with a risk of the hashtag. For example, a new hashtag will have a significantly higher risk than a trending hashtag, or near trending hashtag. Alternatively, a bidding system may be provided to allow for a restaurant to pick up at least one further hashtag or trending data set. In this way, the market will govern the price of the hashtag rather than a pre-set price being provided to the restaurant profile.

The hashtag may also be associated with at least one data set. Hashtags may be referred to more broadly as “metadata” and may be any predetermined data set.

While the present disclosure primarily concerns restaurants, the restaurant may instead be, for example, a bar, a supermarket, a liquor store, a retailer, a vendor, a stall holder, a charity, a club or any other predetermined entity.

Preferably the user device is at least one of; a computer, a smart phone, a cell phone, a tablet computer, a laptop, a notebook, a smart device, a television or any other device which can be adapted to display data or digital assets.

In yet a further embodiment of the system, the system hashes a metadata tag and provides a private key to an entity to allow for an exclusive association of the metadata tag with the entity and/or a promotion of the entity. The metadata tag may also be associated with a public key in relation to the private key. In this way an exclusive relationship may be formed between an entity and the metadata tag. However, it will be appreciated that any entity possessing the private key may also exploit the metadata tag is desired.

At least one embodiment of the hardware and operating environment may comprise a general purpose computing device in the form of a computer (e.g., a personal computer, workstation, or server), including one or more processing units, a system memory, and a system bus that operatively couples various system components including the system memory to the processing unit. There may be only one or there may be more than one processing unit, such that the processor of computer comprises a single central-processing unit (CPU), or a plurality of processing units, commonly referred to as a multiprocessor or parallel-processor environment. In various embodiments, computer is a conventional computer, a distributed computer, or any other type of computer.

The system bus can be any of several types of bus structures including a memory bus or memory controller, a peripheral bus, and a local bus using any of a variety of bus architectures. The system memory can also be referred to as simply the memory, and, in some embodiments, includes read-only memory (ROM) and random-access memory (RAM). A basic input/output system (BIOS) program, containing the basic routines that help to transfer information between elements within the computer, such as during start-up, may be stored in ROM. The computer further includes a hard disk drive for reading from and writing to a hard disk, not shown, a magnetic disk drive for reading from or writing to a removable magnetic disk, and an optical disk drive for reading from or writing to a removable optical disk such as a CD ROM or other optical media.

The hard disk drive, magnetic disk drive, and optical disk drive couple with a hard disk drive interface, a magnetic disk drive interface, and an optical disk drive interface, respectively. The drives and their associated computer-readable media provide non volatile storage of computer-readable instructions, data structures, program modules and other data for the computer. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk, optical disk, ROM, or RAM, including an operating system, one or more application programs, other program modules, and program data. Programming for implementing one or more processes or method described herein may be resident on any one or number of these computer-readable media.

A user may enter commands and information into computer through input devices such as a keyboard and pointing device. Other input devices (not shown) can include a microphone, joystick, game pad, satellite dish, scanner, or the like. These other input devices are often connected to the processing unit through a serial port interface that is coupled to the system bus, but can be connected by other interfaces, such as a parallel port, game port, or a universal serial bus (USB). A monitor or other type of display device can also be connected to the system bus via an interface, such as a video adapter. The monitor can display a graphical user interface for the user. In addition to the monitor, computers typically include other peripheral output devices (not shown), such as speakers and printers.

The computer may operate in a networked environment using logical connections to one or more remote computers or servers, such as remote computer. These logical connections are achieved by a communication device coupled to or a part of the computer; the invention is not limited to a particular type of communications device. The remote computer can be another computer, a server, a router, a network PC, a client, a peer device or other common network node, and typically includes many or all of the elements described above I/O relative to the computer, although only a memory storage device has been illustrated. The logical connections depicted in FIG. 9 include a local area network (LAN) and/or a wide area network (WAN). Such networking environments are commonplace in office networks, enterprise-wide computer networks, intranets and the internet, which are all types of networks.

When used in a LAN-networking environment, the computer is connected to the LAN through a network interface or adapter, which is one type of communications device. In some embodiments, when used in a WAN-networking environment, the computer typically includes a modem (another type of communications device) or any other type of communications device, e.g., a wireless transceiver, for establishing communications over the wide-area network, such as the internet. The modem, which may be internal or external, is connected to the system bus via the serial port interface. In a networked environment, program modules depicted relative to the computer can be stored in the remote memory storage device of remote computer, or server. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

The claims defining the invention are as follows:

1. A system for transacting trending assets, the system comprising;
at least one metadata tag for sale;
an entity making a submission for the at least one metadata tag via an application accessible on an entity device;
the submission for the at least one metadata tag being transmitted via the entity device to a server and
wherein if the submission is confirmed by the system, the metadata tag is associated with the entity and wherein the at least one metadata tag is viewable by a user via a user application on a user device.

2. The system as claimed in claim 1, wherein the system collects data in relation to the entity geographical location

3. The system as claimed in claim 1, wherein the sale is an auction.

4. The system as claimed in claim 1, wherein the sale is a fixed price.

5. The system as claimed in claim 1, wherein a price for the sale is in relation to user feedback with respect to a number of shares of the metadata tag.

6. The system as claimed in claim 1, wherein the metadata tag associated with the entity is assigned to at least one promotion.

7. The system as claimed in claim 1, wherein the system issues a private key to the entity when the submission is confirmed by the system.

8. The system as claimed in claim 1, wherein the user application displays a metadata tag feed on the user device.

9. The system as claimed in claim 8, wherein the system displays an entity promotion with associated metadata tag in the user feed.

10. The system as claimed in claim 1, wherein metadata tag is assigned to a good for sale, in which the good for sale is displayable on a user feed.

11. The system as claimed in claim 10, wherein the good for sale is a food item.

12. The system as claimed in claim 1, wherein the system is adapted to capture at least one data set from a user at least when the user signs up for using the user application.
